(19) United States
(12) Patent Application Publication
(10) Pub. No.: US 2005/0211006 A1
(43) Pub. Date: Sep. 29, 2005

(54) Linear step motor

(76) Inventor: Elmar Breitbach, Gottingen (DE)

Correspondence Address: Scott A. Horstemeyer;THOMAS, KAYDEN, HORSTEMEYER & RISLEY, L.L.P., Suite 1750, 100 Galleria Parkway, Atlanta, GA, 30339, US

(21) Appl. No.: 11/106,231

(22) Filed: Apr. 14, 2005

Related U.S. Application Data
(63) Continuation of application No. PCT/EP03/11317, filed on Oct. 13, 2003.

(30) Foreign Application Priority Data
Oct. 17, 2004 (DE) 102 48 426.0

(51) Int. Cl. F16H 27/02

(52) U.S. Cl. 74/88

(57) ABSTRACT

A linear step motor (1) comprises a shaft (2) which is longitudinally moveable in two opposite directions; two blocking devices (4, 5) arranged at a distance with which the shaft can alternately be fixed; at least one linear solid-type actuator for modifying the distance between said blocking devices being; one blocking device fixing the shaft when the at least one linear actuator changes the distance between the blocking devices in such a way that the blocking devices move towards each other, and the other blocking device fixing the shaft when the at least one linear actuator changes the distance between the blocking devices in such a way that the blocking devices moving away from each other, in order to displace the shaft in one direction; and an operation distance enlarging device (9) which is provided for the at least one linear actuator, the operation distance enlarging device comprising at least one lever arrangement with levers (11, 17) connected via joints (10,12,16,18) and with a gearing up lever ratio, the lever arrangement gearing up an operation distance of the linear actuator into an enlarged variation of the distance of the blocking devices, and all joints of the at least one operation distance enlarging device being solid-type joints.

### CROSS REFERENCE TO RELATED APPLICATIONS

This application is a continuation of International Application PCT/EP 03/11317 with an international filing date of Oct. 13, 2003 and claiming the benefit of co-pending German Patent Application No. 102 48 426.0 entitled “Linearschriftmotor”, filed on Oct. 17, 2002.

### FIELD OF THE INVENTION

The invention relates to a linear step motor. Particularly, the invention relates to a linear step motor comprising a shaft with is longitudinally moveable in opposite directions, and two blocking devices with which the shaft can alternately be fixed, the distance between said blocking devices being modifiable by means of a linear actuator in form of a solid-type actuator, one blocking device fixing the shaft when the blocking devices move towards each other, and the other blocking device fixing the shaft when the blocking devices moving away from each other, in order to displace the shaft in one direction. A particular field of application to which the application relates are direct drives for valve control.

### BACKGROUND OF THE INVENTION

A linear step motor comprising a shaft which is longitudinally moveable in two opposite directions, and two locking devices with which the shaft may alternately be fixed is known as a so called Inch-Worm. Here, a linear actuator in the form of a piezoelectric solid-type actuator is integrated into the shaft between the two blocking devices which have fixed positions, the length of the shaft being periodically changeable by means of operating the actuator. If, for example, the blocking device arranged at the back is always fixing the shaft when it is extended by means of the solid-type actuator, and it is free in the area of the blocking device arranged at the front, and if the blocking device arranged at the front is always fixing the shaft when it is shortened by means of the solid-type actuator, and it is free in the area of the blocking device at the back, the shaft moves forwards step by step. When the functions of fixing and releasing are changed between the blocking devices, the shafts move to the back. The blocking devices of the known linear motor are also based on piezoelectric solid-type-actuators which may be operated at a high frequency. The velocities in longitudinally moving the shaft, which may be achieved with the known linear motors, are only small, however, because they are limited by the comparatively small elongation of the shaft between the blocking devices by means of the solid-type actuator integrated into the shaft there. Further, the total moving distance of the shaft in each direction is limited to the free distance of the blocking devices, from which the length of the solid-type actuator integrated into the shaft is additional to be deducted. Thus, the known linear motor is not suited for various applications.

For a direct valve control in an Otto or Diesel engine, for example, moving speeds are needed for a valve rocker actuating a valve, which are by two magnitudes higher than they are realizable with an Inch-Worm.

A linear step motor having the features of the preamble of claim 1 is, for example, known from DE 100 46 137 A1. In contrast to the previously described Inch-Worm the length of the shaft is constant. Thus, the construction of the shaft is simplified. Further, no control connection to the shaft has to be provided. Additionally, the total moving distance of the shaft in both directions is not limited despite by the length of the shaft itself. Thus, shafts of quasi-infinite length, like for example material drawn from a stock, can be handled in a reasonable way. Instead of the length of the shaft, the distance of the blocking devices from each other is modified in a linear motor having the features of the preamble of claim 1. The known linear step motors having the features of the preamble of claim 1, however, suffer from the linear actuators in form of solid-type actuators only having comparatively small operation distances, so that the moving distance of the shaft in each of the steps of the linear step motor is only small.

From JP 02241373 A (in: Patent Abstracts of Japan, 1990) a linear step motor having the features of the preamble of claim 1 is known, in which each of the two blocking devices also comprises a solid-type actuator for fixing the shaft thereto.

Operation distance enhancing devices for solid-type actuators comprising lever arrangements with gearing lever ratios, which gear up the actuating distance of the respective linear actuator, are known, for example, from DE 196 40 108 C1, DE 100 13 752 A1 and DE 201 06 831 U1. The joints of these lever arrangements are highly problematic, particularly with operating the solid-type actuators in opposite directions and at a high frequency.

Known direct drives for valve control in Otto and Diesel engines comprise an armature arranged at the valve rocker which is spring elastically supported in the direction of the valve movement. One solenoid is provided each for holding the valve in an open position and in a closed position, the solenoid acting upon the armature. The movement of the armature between both positions takes place as a result of the restoring force of its elastic support. Thus, the moving speed is dependent on the eigen frequency of the formed spring-mass-system. Although such a direct drive for valve control has been developed over several years (W. Salber et al.: Der elektromechanische Ventiltrieb—Systembaustein für zukünftige Antriebskonzepte (The electro-mechanic Valve Drive—System Component for future Drive Concepts), part 1 and part 2 in MTZ Motortechnik Zeitschrift (Motor Technique Journal) 61 (2000) and 61 (2001)) no application in a series product has been taken place up to now.

Further, hydraulic direct drives have been considered for valve control. Here, in general, a higher number of parameters of the valve movement may be controlled than in case of electro-magnetic concepts described here before; hydraulic direct drives however, show limited dynamics.

There is still a need of a linear step motor of the type described at the beginning, with which basically higher velocities in longitudinally moving the shaft may be realized so that it is, for example, suited as a direct drive for valve control in Otto and Diesel engines.

### SUMMARY OF THE INVENTION

The invention provides a linear step motor comprising a shaft which is longitudinally moveable in two opposite directions; two blocking devices arranged at a distance with which the shaft can alternately be fixed; at least one linear actuator for modifying the distance between said blocking devices being, the linear actuator being a solid-type actuator; one blocking device fixing the shaft when the at least one linear actuator changes the distance between the blocking devices in such a way that the blocking devices move towards each other, and the other blocking device fixing the shaft when the at least one linear actuator changes the distance between the blocking devices in such a way that the blocking devices moving away from each other, in order to displace the shaft in one direction; and an operation distance enlarging device which is provided for the at least one linear actuator, the operation distance enlarging device comprising at least one lever arrangement with levers connected via joints and with a gearing up lever ratio, the lever arrangement gearing up an operation distance of the linear actuator into an enlarged variation of the distance of the blocking devices, and all joints of the at least one operation distance enlarging device being solid-type joints.

Further, the invention provides a direct drive for valve control in a combustion engine selected from the group consisting of Otto and Diesel engines, the direct drive including a linear step motor comprising a shaft which is longitudinally moveable in two opposite directions; two blocking devices arranged at a distance with which the shaft can alternately be fixed each of the two blocking device comprising a solid-type actuator for fixing the shaft; at least one linear actuator for modifying the distance between said blocking devices being, the linear actuator being a solid-type actuator; one blocking device fixing the shaft when the at least one linear actuator changes the distance between the blocking devices in such a way that the blocking devices move towards each other, and the other blocking device fixing the shaft when the at least one linear actuator changes the distance between the blocking devices in such a way that the blocking devices moving away from each other, in order to displace the shaft in one direction; and an operation distance enlarging device which is provided for the at least one linear actuator, the operation distance enlarging device comprising at least one lever arrangement with levers connected via joints and with a gearing up lever ratio, the lever arrangement gearing up an operation distance of the linear actuator into an enlarged variation of the distance of the blocking devices, and all joints of the at least one operation distance enlarging device being solid-type joints.

Each linear actuator in the new linear step motor is a solid-type actuator to make use of its operatability at high frequency and its inherent guiding qualities. For each linear actuator a device for enlarging the operation distance is provided, which gears up the actuating path of the linear actuator into an enlarged change of the distance of the blocking devices. This operation distance enlarging device realizes a quantum jump in the moving velocities of the shaft of the linear motor, as the moving distance of the shaft in each single step of the linear step motor is essentially enlarged. Further, each operation distance enlarging device further comprises at least one lever arrangement having a gearing up lever ratio. Operation distance enlarging devices having a plurality of lever arrangements arranged in series, the gearing up lever ratios of which are multiplied with each other, are preferred. In the operation distance enlarging devices all joints are solid-type joints. The elastic properties of the solid-type joints may be used in the sense of a high inherent stiffness with a high eigen frequency for realizing a high operation frequency. This is particularly without any problems, if, for example, solid-type actuators on a piezoelectric or magnetostrictive basis are used, which are capable of providing high forces for purposefully overcoming the inherent stiffnesses. Solid-type actuators on a piezoelectric or magnetostrictive basis are known as piezoelectric and magnetostrictive transducers, respectively.

In the new linear step motor it is possible that in changing the distance of the blocking devices the position of only one blocking device is changed with regard to a fixed basis, i.e. that the other blocking device has a fixed position.

It is preferred, however, if in changing the distance of the blocking devices the positions of both blocking devices are changed in opposite directions with regard to a fixed basis. In this way, with a same change of position of each blocking device, a double moving distance of the shaft can be realized in each step.

One linear actuator may be provided for changing the distance of both blocking devices. However, one linear actuator can also be provided for each blocking device.

The blocking devices of the new linear step motor may also comprise solid-type actuators to alternately fix the shaft with their help.

### BRIEF DESCRIPTION OF THE DRAWINGS

The invention can be better understood with reference to the following drawings. However, the components in the drawings are not necessarily to scale, emphasis instead being placed upon clearly illustrating the principles of the present invention. In the drawings, like reference numerals designate corresponding parts throughout the several views.

FIG. 1 shows the general construction of the new linear step motor;

FIG. 2 shows an operation distance enlarging device for a linear actuator changing the distance of blocking devices of the new linear step motor from a first perspective;

FIG. 3 shows the operation distance enlarging device according to FIG. 2 in a first operation position in a view perpendicular to that one of FIG. 2;

FIG. 4 shows the operation distance enlarging device according to FIGS. 2 and 3 in a second operation position in a view corresponding to FIG. 3; and

FIG. 5 shows the operation distance enlarging device according to FIGS. 2 to 4 in a third operation position in a view corresponding to FIGS. 3 and 4.

### DETAILED DESCRIPTION

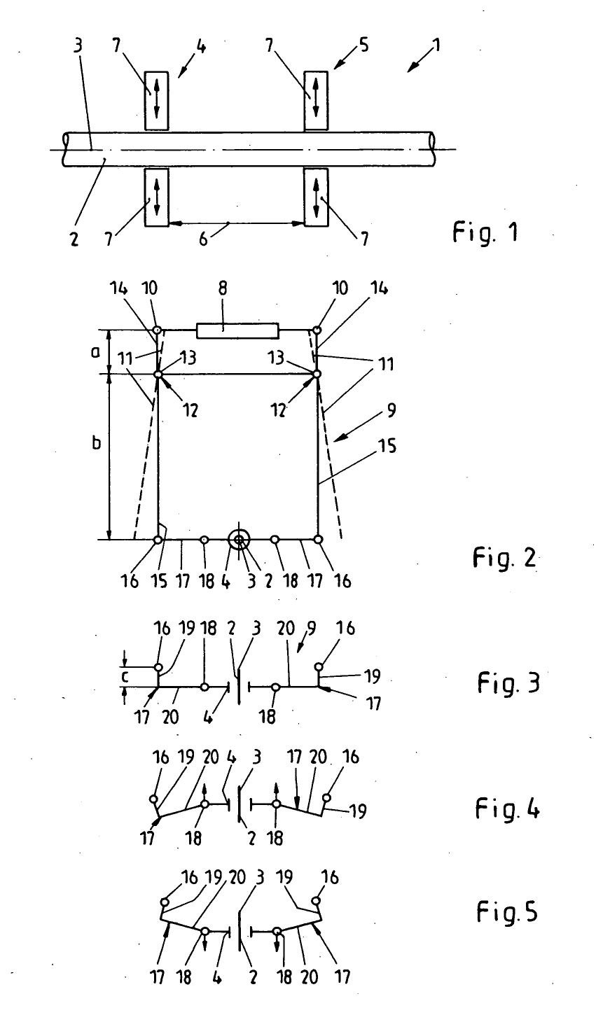

Referring now in greater detail to the drawings, the linear step motor 1 depicted in FIG. 1 comprises a shaft 2, which is moveable in a direction of its longitudinal axis 3. The movability of the shaft 2 is realized by means of two blocking devices 4 and 5, the distance 6 of which may be varied. The variability of the distance 6 can be based on only one of the two blocking devices 4 and 5 being moveable with regard to the other, whereas the other is fixed. Both blocking devices 4 and 5, however, can also be moveable in opposite directions with regard to a fixed basis. In each case, the shaft 2 is alternately fixed at the two blocking devices 4 and 5, whereas the blocking devices 4 and 5 are periodically moved away from and towards each other. If, for example, the shaft 2 is fixed at the blocking device 4 during moving the blocking devices 4 and 5 towards each other, i.e. during reducing the distance 6, whereas the shaft 2 is free at the blocking device 3 and may be displaced with regard to it, and if the shaft is fixed at the blocking device 5 during moving the blocking devices 4 and 5 away from each other, i.e. during increasing the distance 6, whereas the shaft 2 is free at the blocking device 4, and if the movements of the blocking devices towards each other and away from each other are repeated several times, the shaft 2 moves in the direction of its longitudinal axis 3 step by step to the right hand side of FIG. 1. If the actuation of the blocking devices 4 and 5 is inverted, the shaft 2 moves in the opposite direction step by step to the left hand side of FIG. 1. The blocking devices 4 and 5 can each comprise solid-type actuators 7 for fixing the shaft 2, the shaft 2 being fixed upon actuating the solid-type actuators 7. The solid-type actuators 7 may particularly be piezoelectric of magnetostrictive actuators.

A solid-type actuator 8 is provided anyway provided for varying the distance 6 between the blocking devices 4 and 5. An operation distance enlarging device 9 which is depicted in FIG. 2 is provided to enlarge the actuating distance of this solid-type actuator 8 so that the shaft 2 is moved over a comparatively high distance in each step of the linear step motor 1 according to FIG. 1. The solid-type actuator 8 is jointed to two two arm gear levers 11 via joints 10, the two arm gear levers 11 each pivoting around joints 12 having pivot axis 13, the distance between the pivot axis 13 being fixed, and the joints 10 being arranged at the free ends of the shorter arms 14 of the gear levers 11. The longer arms 15 of the gear levers 11 engage intermediate levers 17 via joints 16, the intermediate levers 17 engaging the blocking device 4 depicted here via further joints 18. The shaft 2 runs through the blocking device 4. When the solid-type actuator 8 is operated in the sense of a length contraction, the joints 10 move toward each other, and the gear levers 11 get into the orientation which is depicted in FIG. 2 with dashed lines. This results into a displacement of the blocking device 4 perpendicular to the drawing plane of FIG. 2, which will be explained in detail with reference to FIGS. 3 to 5.

FIG. 3 shows the starting position, and it can be seen that the intermediate levers 17 are elbows, the shorter arms 19 of which run in parallel to the longitudinal axis 3 of the shaft 2, and the longer arms 20 of which are oriented perpendicular to the longitudinal axis 3 in the starting position of FIG. 3. If the actuator 8 according to FIG. 2 is now operated in such a way that the joints 10 are moved towards each other or the joints 16 are moved away from each other, the operation position which is depicted in FIG. 4 results. The intermediate levers 17 are pulled away form each other at the joints 16. Thus, the joints 18 move upwards in FIG. 4 and take the blocking device 4 with them. Vice versa, the joints 18 and the blocking device 4 move downwards upon pressing the joints 16 together, which corresponds to pressing the joints 10 according to FIG. 2 away from each other, which is depicted in FIG. 5. The total gearing up of the operation distance by means of the operation distance enlarging device 9 according to FIGS. 2 to 5 may be estimated by the product b/a*d/c, a being the length of the short arms 14, and b being the length of the long arms 15 of the gearing up levers 11, whereas c being the length of the short arms 19, and d being the length of the long arms 30 of the intermediate levers 17. In contrast to the gearing up levers 11, which are additionally supported at the joints 12, the intermediate levers 17 are only pivoting about t heir ends. All joints 10, 12, 16 and 18 of the operation distance enlarging device 9 are solid-type joints having an inherent stiffness tuned to the solid-type actuator 8. In the linear step motor according to FIG. 1 the solid-type actuator 8 can at the same time move both blocking devices 4 and 5 in opposite directions, to this end it is only necessary to arrange the intermediate levers 17 mirror-symmetrically with regard to a symmetry plan running perpendicular to the longitudinal axis 3 of the shaft 2 between the blocking devices 4 and 5. I.e. a separate pair of intermediate levers 17 is to be provided for each of the blocking devices 4 and 5. The gearing up levers 11 can, however, be common to both blocking devices 4 and 5, for example, so that one single pair is sufficient here. Naturally, it is also possible, to provide a separate pair of gearing up levers 11 for each of the blocking devices 4 and 5. It is also possible to move each of the blocking devices 4 and 5 by means of a separate solid-type actuator 8 to realize variations of the distance 6 according to FIG. 1.

In the new step motor the moving distance of the shaft 2 can be varied in every step by means of the strength of the operation of the solid-type actuator 8. The moving velocity of the shaft 2 may be varied by the frequency at which the solid-type actuators 7 and 8 are operated. The total moving distance of the shaft 2 can be determined by the number of the single moving steps, and it may reach any desired value.

### LIST OF REFERENCE NUMERALS

1 linear step motor
2 shaft
3 longitudinal axis
4 blocking device
5 blocking device
6 distance
7 solid-type actuator
8 solid-type actuator
9 operation distance enlarging device
10 joint
11 gearing up lever
12 joint
13 pivot axis
14 arm
15 arm
16 joint
17 intermediate lever
18 joint
19 arm
20 arm

1. A linear step motor comprising:
a shaft which is longitudinally moveable in two opposite directions;
two blocking devices arranged at a distance with which the shaft can alternately be fixed;
at least one linear actuator for modifying the distance between said blocking devices being, the linear actuator being a solid-type actuator;
one blocking device fixing the shaft when the at least one linear actuator changes the distance between the blocking devices in such a way that the blocking devices move towards each other, and the other blocking device fixing the shaft when the at least one linear actuator changes the distance between the blocking devices in such a way that the blocking devices moving away from each other, in order to displace the shaft in one direction; and
an operation distance enlarging device which is provided for the at least one linear actuator, the operation distance enlarging device comprising at least one lever arrangement with levers connected via joints and with a gearing up lever ratio,
the lever arrangement gearing up an operation distance of the linear actuator into an enlarged variation of the distance of the blocking devices, and
all joints of the at least one operation distance enlarging device being solid-type joints.

2. The linear step motor of claim 1, wherein when the at least one linear actuator changes the distance between the blocking devices in such a way that only a position of one blocking device which is varied with regard to a fixed basis.

3. The linear step motor of claim 1, wherein when the at least one linear actuator changes the distance between the blocking devices in such a way that positions of both blocking devices are varied with regard to a fixed basis.

4. The linear step motor of claim 2, wherein one linear actuator is provided for varying the position of one blocking device with regard to the fixed basis.

5. The linear step motor of claim 3, wherein one linear actuator is provided for varying the positions of both blocking devices with regard to the fixed basis.

6. The linear step motor of claim 3, wherein one linear actuator is provided for each of the blocking devices for varying the positions of both blocking devices with regard to the fixed basis.

7. The linear step motor of claim 1, wherein each of the two blocking devices comprises a solid-type actuator.

8. The linear step motor of claim 1, wherein the at least one solid-type actuator is selected from the group consisting of piezoelectric and magnetostrictive transducers.

9. The linear step motor of claim 6, wherein each of the solid-type actuators is selected from the group consisting of piezoelectric and magnetostrictive transducers.

10. The linear step motor of claim 7, wherein each of the solid-type actuators is selected from the group consisting of piezoelectric and magnetostrictive transducers.

11. A direct drive for valve control in a combustion engine selected from the group consisting of Otto and Diesel engines, the direct drive including a linear step motor comprising:
a shaft which is longitudinally moveable in two opposite directions;
two blocking devices arranged at a distance with which the shaft can alternately be fixed each of the two blocking device comprising a solid-type actuator for fixing the shaft;
at least one linear actuator for modifying the distance between said blocking devices being, the linear actuator being a solid-type actuator;
one blocking device fixing the shaft when the at least one linear actuator changes the distance between the blocking devices in such a way that the blocking devices move towards each other, and the other blocking device fixing the shaft when the at least one linear actuator changes the distance between the blocking devices in such a way that the blocking devices moving away from each other, in order to displace the shaft in one direction; and
an operation distance enlarging device which is provided for the at least one linear actuator, the operation distance enlarging device comprising at least one lever arrangement with levers connected via joints and with a gearing up lever ratio,
the lever arrangement gearing up an operation distance of the linear actuator into an enlarged variation of the distance of the blocking devices, and
all joints of the at least one operation distance enlarging device being solid-type joints.

12. The direct drive of claim 11, wherein when the at least one linear actuator changes the distance between the blocking devices in such a way that only a position of one blocking device is varied with regard to a fixed basis.

13. The direct drive of claim 11, wherein when the at least one linear actuator changes the distance between the blocking devices in such a way that positions of both blocking devices are varied with regard to a fixed basis.

14. The direct drive of claim 12, wherein one linear actuator is provided for varying the position of one blocking device with regard to the fixed basis.

15. The direct drive of claim 13, wherein one linear actuator is provided for varying the positions of both blocking devices with regard to the fixed basis.

16. The direct drive of claim 13, wherein one linear actuator is provided for each of the blocking devices for varying the positions of both blocking devices with regard to the fixed basis.

17. The direct drive of claim 11, wherein the at least one solid-type actuator is selected from the group consisting of piezoelectric and magnetostrictive transducers.

18. The direct drive of claim 16, wherein each of the solid-type actuators is selected from the group consisting of piezoelectric and magnetostrictive transducers.
